(19) United States
(12) Patent Application Publication
(10) Pub. No.: US 2013/0328657 A1
(43) Pub. Date: Dec. 12, 2013

(54) CIRCUIT BREAKER THERMAL LOAD VISUAL GAUGE

(71) Applicants: William Joseph Broghammer, Anamosa, IA (US); Chad R. Mittelstadt, Cedar Rapids, IA (US)

(72) Inventors: William Joseph Broghammer, Anamosa, IA (US); Chad R. Mittelstadt, Cedar Rapids, IA (US)

(73) Assignee: Schneider Electric USA, Inc., Palatine, IL (US)

(21) Appl. No.: 13/494,457

(22) Filed: Jun. 12, 2012

(51) Int. Cl. H01H 71/04

(52) U.S. Cl. 337/79

(57) ABSTRACT

A thermal gauge for circuit breaker useful for indicating operating conditions, such as in a miniature circuit breaker, has a thermal transducer thermally connected to the current path of the circuit breaker such that heat transfer causes the transducer to give a visible display of heat, latch engagement, or current draw within the breaker directly through a window in the face of the circuit breaker.

### BACKGROUND OF THE INVENTION

1. Field Of The Invention

The present invention relates generally to electrical distribution equipment and control apparatus therefore, such as circuit breakers. The invention relates more particularly to an indicator of thermal activity within the circuit breaker and especially to an inexpensive thermal indicator within high commercial volume breakers commonly used in the residential market and known to those in the art as miniature circuit breakers.

2. Discussion of the Known Art

Within the general context of the art and the present disclosure it will be understood that a common miniature circuit breaker will have a dielectric, i.e. nonconducting, case enclosing a current path comprising a line terminal connected to the central electrical distribution bus for line power, a braided wire connection leading from the line terminal to a thermo-magnetic trip unit comprising a magnetic yoke and thermally sensitive bimetal which in ordinary operation pass current through to a load terminal and then on to the branch circuit being protected by the breaker. In the case of overcurrent conditions the thermo-magnetic trip unit will react to trip the breaker causing a movable electrical contact to separate from a fixed contact and thereby open the circuit to protect the load.

In the present art, when it comes to the operational state of an inexpensive thermo-mechanical breaker such as an miniature circuit breaker, there is no easy way to readily determine either the present current draw or in what position the thermal element, i.e. bimetal, might be within the breaker (while still conducting) and therefore how close the breaker may be to tripping.

In the known art one may have to purchase and install a secondary measurement system e.g., such as a POWERLOGIC brand Branch Circuit Power Meter available from Schneider Electric USA, Inc., to know how much electricity is being used by a circuit or remove the deadfront from the circuit breaker panel to access a load wire for current usage measurement. This requires proper personal protective equipment (PPE) and labor time even if all that is needed is a simple estimate, e.g. that load use is at greater than 50% of total breaker capacity, to answer a diagnostic question.

Further in terms of breaker operation, current draw measurement does not always provide a complete understanding of how close a breaker is to tripping, as current draw is a secondary parameter of latch engagement. If the breaker has a loose connection, a normally low current load may generate excessive heat making a circuit breaker trip thermally. In applications such as a data center which require constant access to power, such nuisance tripping is a big issue.

Also, miniature circuit breaker's have a limited life and can only handle a relatively small number of high current interruptions before losing continuity. in the current path due to contact erosion or fouling. This extreme current level elevates the bimetal temperature significantly above the normal thermal tripping temperature and may change the shape or operating characteristics, or both, of the bimetal or other internal parts and hence the operation of the breaker. There is little way of telling that such high current interruptions have taken place other than a gross physical inspection of the outside of the breaker.

### SUMMARY OF THE INVENTION

Due to the above limitations a means to readily ascertain thermal activity within the breaker would be welcome in the art to indicate either or both of present operating conditions and indications of the remaining useful life of the breaker. To that end, the present invention in its various aspects and embodiments teaches and provides a thermal indicator for the breaker by which both of these conditions can be made visible to the user without exposure to live circuit components and at a very reasonable product cost.

Miniature circuit breakers typically have a bimetal element in the current path that moves with current draw by a load on a circuit. The bimetal then releases a latch if the current magnitude and time (I²*t) exceeds the trip setting of manufacturer. Change in temperature drives the bimetal movement and has a strong correlation to the trip point of the breaker. A thermal gauge is a simple method to visually indicate the amount of latch engagement and how close a circuit breaker is to the trip point, or possibly how much current is being drawn by a load.

In the current path of the circuit breaker a thermal transducer is located for forming a directly observable indication of circuit breaker thermal operating conditions visible from outside of the circuit breaker. The thermal transducer may provide a measurement, visual display, and if desired, a record of the extreme temperature reading. The thermal transducer operates without additional power, i.e. it is not parasitic. The electrical power normally passing through the circuit breaker generates heat which is registered as a color change of a chromic element or a mechanical movement against a scale. The temperature indication can be a direct measurement of, or may be correlated to, the relative position of the mechanical latch members of the trip unit. The thermal transducer preferably but not necessarily has a physical connection to the current path of the circuit breaker to receive heat transfer through conduction. Typically the transducer is sitting on top of a bimetal of the miniature circuit breaker trip unit where heat generation is near its maximum and the physical location is adjacent the front wall or face of the circuit breaker case. An opening within the case of the circuit breaker through which the thermal transducer may be observed visually is then easily provided.

Thus several advantages may be provided by various embodiments of the present invention including providing indications useful to electricians for system maintenance. For example, a non-reversible thermal transducer that captures maximum thermal load can show if a circuit breaker has experienced extreme elevated condition causing significant breaker life consumption and allow a user to plan a product replacement at an opportune time versus peak usage of a circuit. The thermal gauge need not require additional space or have any power requirements, and the costs are minimal due to small size and low part count. In some aspects of the invention the only change to a present circuit breaker case would be an additional viewing window formed therein.

In some aspects the invention may provide a thermo-mechanical transducer utilizing movement of the bimetal of the circuit breaker trip unit, or may be constructed of a bimetallic material in itself. Any desired scale may then be provided in conjunction with an indicator on the bimetal. The user merely has to look at a needle position on the gauge with a desired scale. The indicator may either passively move with the bimetal, or can move due to its own bimetallic properties based on the temperature of the surrounding breaker parts in an active manner. The scale may be adjustable to calibrate the thermal indication. A secondary bimetal is contemplated if the indicator on the gauge needs more movement.

In some aspects of the invention an embodiment may be formed with a thermochromic transducer. This transducer may, like a mechanical transducer, be attached to the current path and is preferably located at or near the top of the bimetal of the miniature circuit breaker trip unit. Although thermochromism is often described as a phenomenon in which certain dyes made from liquid crystals change color reversibly when their temperature is changed, it will be appreciated that some aspects of the present invention contemplate that the thermochromic transducer can include an thermosensitive material with irreversible color change used to indicate and record a temperature extreme which has occurred within the breaker. indicia, including but not limited to alphabetic, numeric, or symbolic indicators; may be included integrally or in conjunction with the thermosensitive color material of the indicator.

Some aspects of the invention may be particularly suited or adaptable for miniature circuit breakers such as QO or HOMELINE breakers sold under the SQUARE D brand by Schneider Electric USA, Inc. Some aspects of the invention may be expanded to encompass indicators for larger breakers utilizing the principles expressed herein.

### BRIEF DESCRIPTION OF THE DRAWINGS

The foregoing and other advantages of the present disclosure will become apparent upon reading the following detailed description and upon reference to the drawings of which:

FIG. 1 is a side view of a miniature circuit breaker with one case half removed to illustrate various components.

FIG. 2 is a front perspective view of the outside of a circuit breaker showing both case halves in place.

FIG. 3 is a detail view of the thermal indicator of the circuit breaker taken from dashed circle 3-3 of FIG. 2.

FIG. 4 is an interior detail of the components of an active indicator mechanism showing a calibration mechanism and a secondary nonreversible indicator.

FIG. 5 is a detail of the components of a thermal gauge according to one aspect of the invention with a thermochromic indicator.

FIGS. 6A and 6B show details of a thermochromic indicator in first and second states.

FIG. 7 is a graph showing a change in the thermochromic indicator.

### DETAILED DESCRIPTION OF THE PREFERED EMBODIMENTS

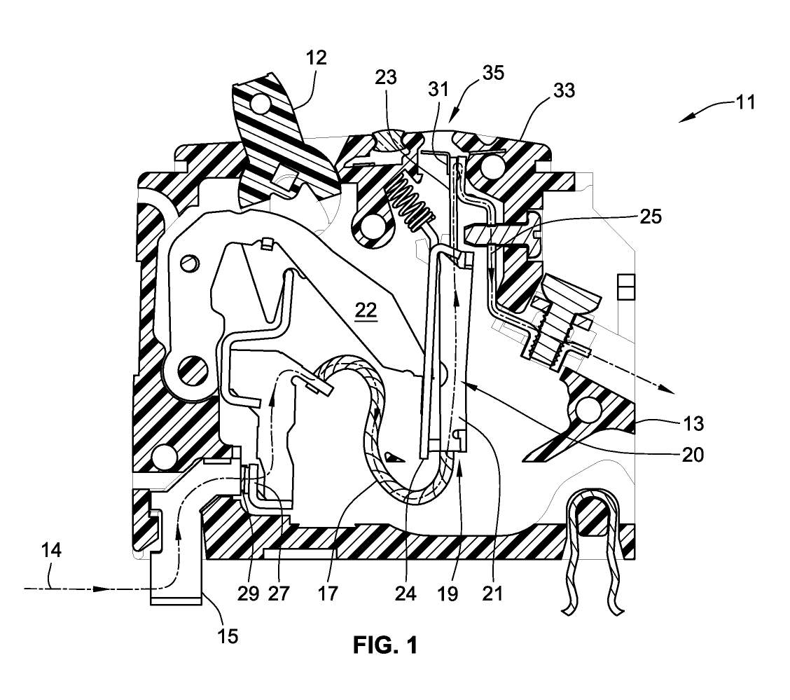

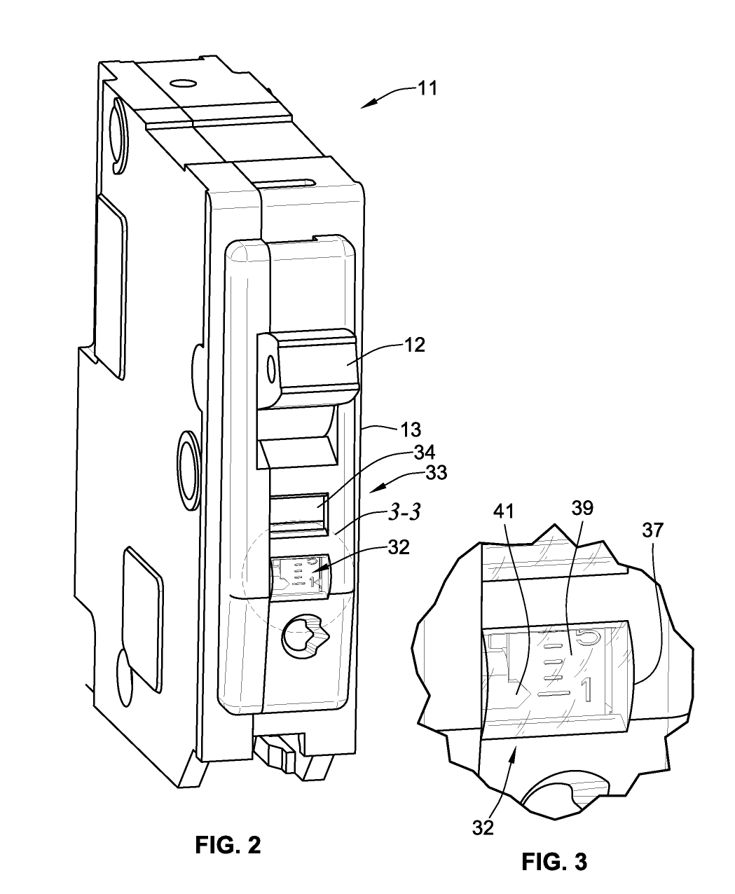

Referring to FIG. 1 a circuit breaker 11 of the miniature type is shown with its operating handle 12 and one case half removed to illustrate various internal components necessary to the current path of the breaker. The circuit breaker has a dielectric, i.e. nonconducting, case 13 enclosing a current path comprising a line terminal 15 for connection to a central electrical distribution bus (not shown) for line power, a braided wire connection 17 leading from the line terminal 15 to a thermo-magnetic trip unit 19, comprising a magnetic yoke 21 carrying a latch plate 24 and a thermally sensitive bimetal 23, which in ordinary operation pass current through to a load terminal 25 and then on to the branch circuit (not shown) being protected by the breaker 11. In the case of overcurrent conditions the thermo-magnetic trip unit 19 will react to trip the breaker latch 20 causing trip lever 22 to separate from latch plate 24 thereby causing a movable electrical contact 27 to separate from a fixed contact 29 attached to the line terminal 15 and thereby open the circuit to protect the load. At the top, in this view, of the current path, attached to the bimetal 23 is a thermal indicator, i.e. transducer, 31 adjacent an inside surface of the wall of the case 13 at the face 33 of the circuit breaker 11. An opening or window 35 has been formed in the case 13 and a viewing lens 37 (FIG. 3) may be inserted therein. Breaker parts unnecessary to explanation of the current invention but understood by the person having ordinary skill in the art will be understood as present but will not be further explained for the sake of brevity.

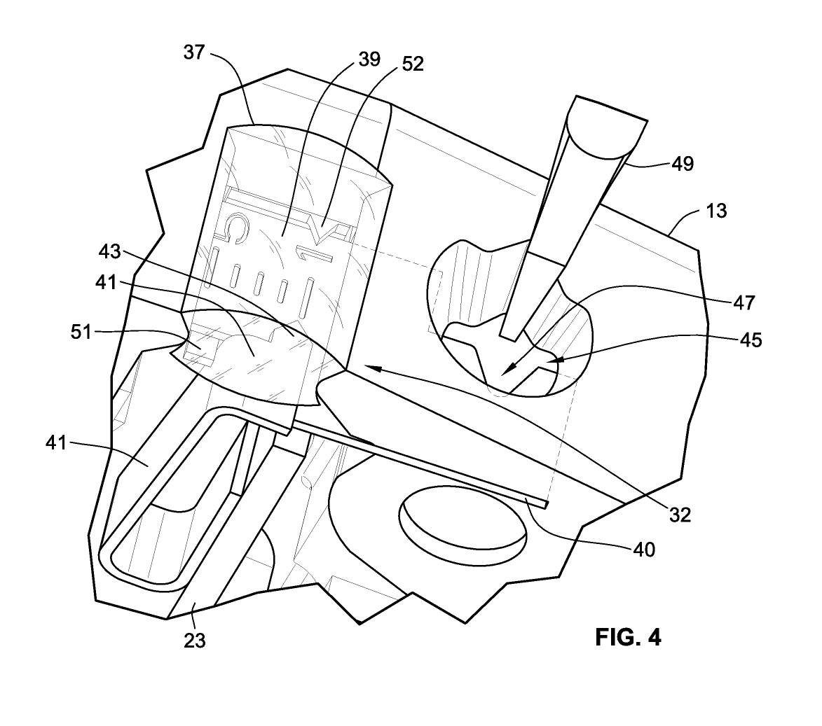

As seen in FIG. 2, a perspective frontal view of a circuit breaker with both case halves in place shows a thermal gauge 32 at the face 33 of the breaker beneath the handle 12. A trip indicator window 34 as known in the art is already in place on the face 33 of the breaker. It is contemplated that a thermal gauge of the present invention may be arranged so as to share the trip indicator window rather than having two windows as illustrated. Referring also to FIGS. 3 and 4, the gauge 32 comprises an adjustable scale 39 and thermally responsive moving indicator 41 covered by the lens 37. The scale may be marked in any variety of desired formats to give relative indications of latch engagement, current draw, internal temperature or the like to the operator.

FIG. 4 is a detail view of the interior a circuit breaker showing parts of the thermal gauge according to one aspect of the invention. As shown, the indicator 41 is “active” in that it is constructed of a bimetal material formed in an open expansible loop. The indicator 41 has an upper surface formed into an arrow shape 43. The open loop is attached to the top of the bimetal 23 of the circuit breaker trip unit (19, FIG. 1) such that it will expand and contract thereby moving over the scale 39 according to temperature transfer to the loop. In this “active” aspect the gauge may give an indirect indication of thermal effect on the engagement of the latch components. It will be appreciated that in other aspects of the invention the indicator may be of the “passive” variety in which the indicator is not formed of thermally responsive material but is merely carried on the thermally responsive bimetal element of the trip unit. In this “passive” aspect the gauge may give a more direct indication of thermal effect on the engagement of the latch components since the position of the trip unit bimetal directly effects latch engagement.

Referring to FIG. 4, there is illustrated a simple but effective construction whereby the scale 39 may be adjusted from the front face of the breaker. In this aspect of the invention the material of the scale 39 beneath the viewing window 35 and its lens 37 has an extension 40 on the inside of the case 13 extending to an adjustment aperture 45. The scale extension material has a “V”-shaped cutaway 47 formed perpendicular to its long axis thereby permitting the user to access the cutaway 47 through the aperture 45 with a screw driver tip 49 and adjust the scale position beneath the arrow shape 43 of the indicator 41 for calibration.

Also in FIG. 4 is shown a secondary indicator 51 mechanically linked to the primary indicator to travel only in one direction, as shown, has an arrow head 52 for persistent or nonreversible recording of the peak temperature excursions within the breaker. It will of course be appreciated that the scale may be marked with any suitable indicia such as a percentage scale, a graphic representation of trip mechanism position, or the like.

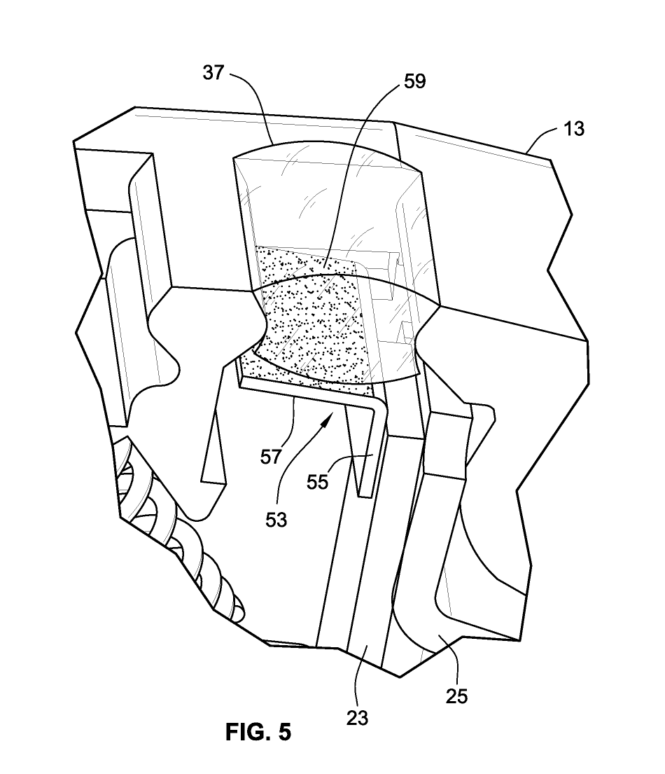

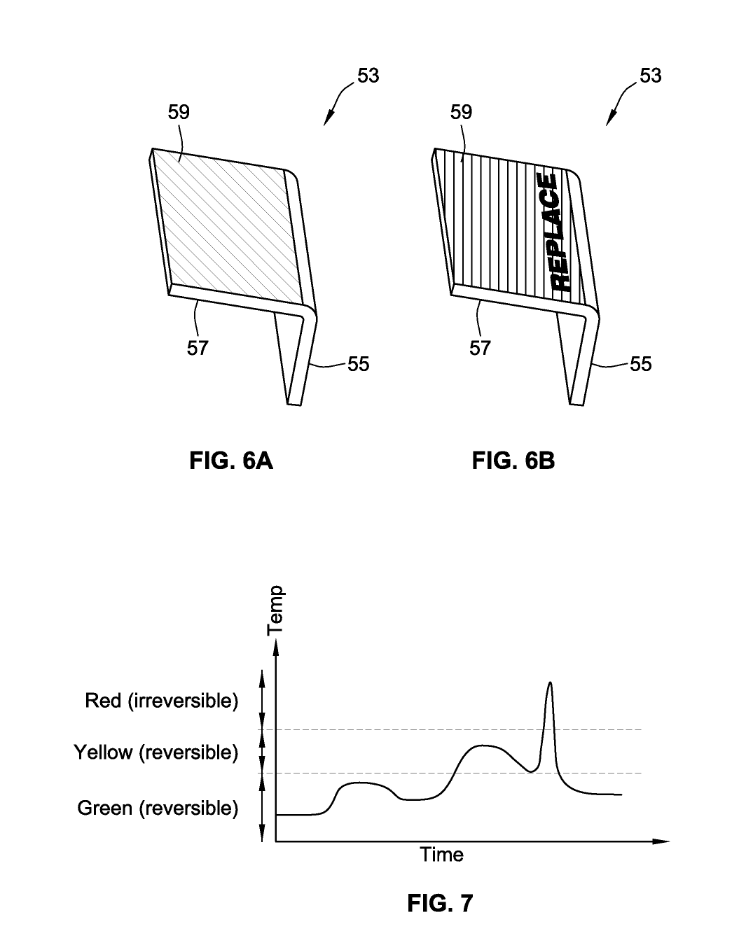

As seen in FIG. 5, a cutaway view of the gauge mechanism having a thermochromic indicator as the transducer for indicating temperature change in the breaker, and the detail of the thermal transducer in two states as it changed from green in FIG. 6A to red in FIG. 6B, with the red warning flag bearing accompanying indicia to replace the breaker. In this aspect the indicator is an angled or L-shaped plate with a first leg 55 physically attached and thermally connected to the top of the breaker trip unit bimetal 23 and a second leg 57 having a indicator surface 59 covered with a transducer of thermochromic material presented to the viewing window lens 37. In other aspects of the invention the thermal transducer may e.g. be attached to terminal 25 or to inside of the breaker case 13. It will be appreciated that the indicator surface 59, if attached to the bimetal 23, will be sized, and the scale or indicator marked, appropriately to account for the range of movement therein.

As seen as in graph of FIG. 7, an exemplary color change indicator is graphed on a Y axis of temperature against an X axis of time. The first or green indication, takes place at a first time and lower temperature and is reversible. The second or yellow indication, takes place at a second later time and higher temperature and is reversible. The third, or red indication, takes place at a later third time and still higher temperature and is irreversible. Thermochromic coloration, or colorations can be selected from any suitable thermochromic technology, and indicia placement arranged as necessary or desired to indicate a variety of temperature conditions within the breaker and may be made to be permanent or reversible as desired by the designer.

Having thus described a thermal load visual gauge for a circuit breaker; it will be appreciated that many variations thereon will occur to the artisan upon an understanding of the present invention, which is therefore to be limited only by the appended claims.

1. A circuit breaker having a current path and a thermal transducer forming a directly observable gauge of a circuit breaker thermal condition visible from outside of the circuit breaker.

2. The circuit breaker of claim 1 wherein the gauge indicates an amount of latch engagement of a trip unit of the circuit breaker.

3. The circuit breaker of claim 1 wherein the thermal transducer has a physical connection to the current path of the circuit breaker.

4. The circuit breaker of claim 1 wherein the current path includes a bimetal and the transducer is attached at one end of the bimetal adjacent a face of the circuit breaker.

5. The circuit breaker of claim 1 further comprising:
an opening within a case of the circuit breaker through which the thermal transducer may be observed visually.

6. The circuit breaker of claim 5 wherein the opening has a lens.

7. The circuit breaker of claim 1 the circuit breaker is an miniature circuit breaker.

8. The circuit breaker of claim 1 wherein the gauge includes a persistent record of the maximum temperature.

9. The circuit breaker of claim 1 wherein the transducer is thermo-mechanical.

10. The circuit breaker of claim 9 wherein the gauge includes a scale.

11. The circuit breaker of claim 10 wherein the gauge includes an indicator.

12. The circuit breaker of claim 11 wherein the indicator is part of the transducer.

13. The circuit breaker of claim 12 where the gauge includes a second indicator.

14. The circuit breaker of claim 1 wherein the transducer is attached to the bimetal of the trip unit of the circuit breaker.

15. The circuit breaker of claim 1 wherein the transducer includes a bimetal of the trip unit of the circuit breaker.

16. The circuit breaker of claim 10 wherein the scale position is adjustable to achieve calibration of the gauge.

17. The circuit breaker of claim 1 wherein the transducer is a thermochromic indicator.

18. The circuit breaker of claim 17 wherein the gauge includes indicia.

19. The circuit breaker of claim 18 wherein the indicia is alphabetic.
